(19) United States
(12) Patent Application Publication
(10) Pub. No.: US 2020/0070223 A1
(43) Pub. Date: Mar. 5, 2020

(54) JIG FOR CLEANING A BOWL OF A SPIN COATER AND APPARATUS FOR CLEANING A BOWL OF A SPIN COATER INCLUDING THE SAME

(71) Applicant: SAMSUNG ELECTRONICS CO., LTD., Suwon-si (KR)

(72) Inventors: Hyun-Joo JEON, Hwaseong-si (KR); Dae-Sung KIM, Suwon-si (KR); Seung-Han LEE, Cheonan-si (KR); Sung-Hyup KIM, Hwaseong-si (KR)

(73) Assignee: SEMES CO., LTD., Cheonan-si (KR)

(21) Appl. No.: 16/374,871

(22) Filed: Apr. 4, 2019

(30) Foreign Application Priority Data
Sep. 4, 2018 (KR) 10-2018-0105117

(51) Int. Cl. B08B 13/00; B05C 11/00; B08B 3/02; B65G 65/00

(52) U.S. Cl. CPC B08B 13/00; B65G 65/00; B08B 3/02; B05C 11/00

(57) ABSTRACT

A jig configured to clean a bowl of a spin coater includes a base disposed on a spin chuck of the spin coater, the base being configured to rotate by the spin chuck. The jig further includes a guide member extending in a first direction from an edge portion of the base toward an inner cover of the bowl and configured to guide a lower cleaning agent injected to a lower surface of the base to the inner cover of the bowl. The inner cover of the bowl is configured to receive photoresist from under the spin chuck.

### CROSS-REFERENCE TO RELATED APPLICATION

This application claims priority under 35 U.S.C. § 119 to Korean Patent Application No. 10-2018-0105117, filed on Sep. 4, 2018 in the Korean Intellectual Property Office (KIPO), the disclosure of which is incorporated by reference herein in its entirety.

### TECHNICAL FIELD

The present inventive concept relates to a jig for cleaning a bowl of a spin coater and an apparatus for cleaning a bowl of a spin coater including the same. More particularly, the present inventive concept relates to a jig for cleaning a photoresist on a bowl of a spin coater and an apparatus for cleaning a bowl of a spin coater including the jig.

### DISCUSSION OF THE RELATED ART

Generally, a spin coater may include a spin chuck for supporting a substrate, a nozzle disposed over the spin chuck to inject a photoresist onto the substrate, and a bowl configured to surround the spin chuck to collect the photoresist overflowing from a surface of the substrate. The photoresist collected in the bowl may be discharged through a discharge hole of the bowl.

Typically, the photoresist may remain on an inner surface of the bowl. The photoresist on the inner surface of the bowl may contaminate the substrate. Thus, the bowl may be periodically cleaned to remove the photoresist. To clean the bowl, a thinner may be injected to the bowl to remove the photoresist after stopping the spin coater.

However, to inject the thinner to the bowl, the spin coater is stopped so that an operating ratio of the spin coater may be decreased. Further, a portion of the photoresist on an inner cover of the bowl under the spin chuck might not be readily removed.

### SUMMARY

According to an exemplary embodiment of the present inventive concept, a jig configured to clean a bowl of a spin coater includes: a base disposed on a spin chuck of the spin coater, the base being configured to rotate by the spin chuck; and a guide member extending in a first direction from an edge portion of the base toward an inner cover of the bowl and configured to guide a lower cleaning agent injected to a lower surface of the base to the inner cover of the bowl. The inner cover of the bowl is configured to receive photoresist from under the spin chuck.

According to an exemplary embodiment of the present inventive concept, a jig configured to clean a bowl of a spin coater includes: a base disposed on a spin chuck of the spin coater, the base being configured to rotate by the spin chuck; a guide member extending in a first direction from an edge portion of the base toward an inner cover of the bowl and configured to guide a lower cleaning agent injected to a lower surface of the base to the inner cover of the bowl, wherein the inner cover of the bowl is configured to receive photoresist from under the spin chuck; a lower guide plate disposed under the base and forming a lower passageway with the base, wherein the lower passageway is configured to guide the lower cleaning agent toward the guide member; and an upper guide plate disposed over the base and forming an upper passageway with the base. The upper passageway is configured to guide an upper cleaning agent injected to an upper surface of the base to an outer cover of the bowl at a side of the spin chuck.

According to an exemplary embodiment of the present inventive concept, an apparatus configured to clean a bowl of a spin coater includes: a jig including: a base disposed on a spin chuck of the spin coater, the base being configured to rotate by the spin chuck; and a guide member extending in a first direction from an edge portion of the base toward an inner cover of the bowl and configured to guide a lower cleaning agent injected to a lower surface of the base to the inner cover of the bowl. The inner cover of the bowl is configured to receive photoresist from under the spin chuck. The apparatus further includes: a lower nozzle disposed under the base to inject the lower cleaning agent toward the lower surface of the base; and an upper nozzle disposed over the base to inject an upper cleaning agent toward an upper surface of the base.

### BRIEF DESCRIPTION OF THE DRAWINGS

The above and other features of the present inventive concept will become more apparent by describing in detail exemplary embodiments thereof, with reference to the accompanying drawings, in which:

FIG. 1 is a cross-sectional view illustrating an apparatus for cleaning a bowl of a spin coater according to an exemplary embodiment of the present inventive concept;

FIG. 2 is an enlarged exploded perspective view illustrating a jig of the apparatus in FIG. 1 according to an exemplary embodiment of the present inventive concept;

FIG. 3 is an enlarged cross-sectional view of a portion III in FIG. 1 according to an exemplary embodiment of the present inventive concept;

FIG. 4 is a cross-sectional view illustrating an apparatus for cleaning a bowl of a spin coater according to an exemplary embodiment of the present inventive concept;

FIG. 5 is an enlarged exploded perspective view illustrating a jig of the apparatus in FIG. 4 according to an exemplary embodiment of the present inventive concept; and

FIG. 6 is an enlarged cross-sectional view of a portion VI in FIG. 4 according to an exemplary embodiment of the present inventive concept.

### DETAILED DESCRIPTION OF THE EMBODIMENTS

Hereinafter, exemplary embodiments of the present inventive concept will be explained in detail with reference to the accompanying drawings.

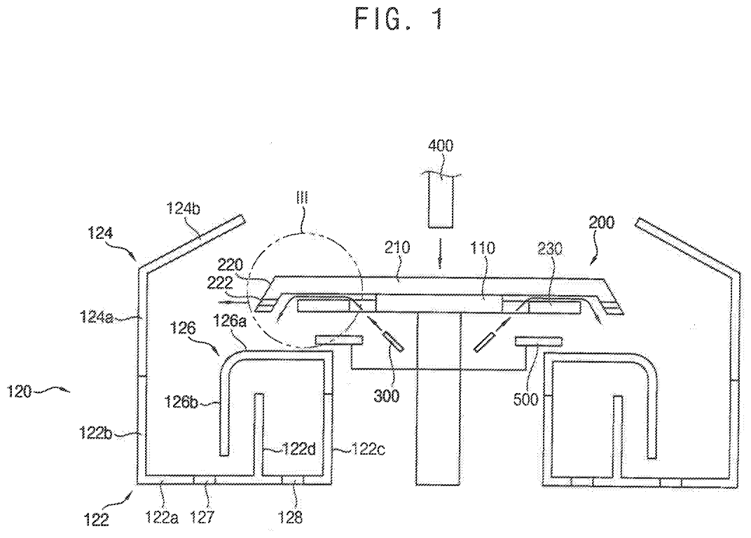

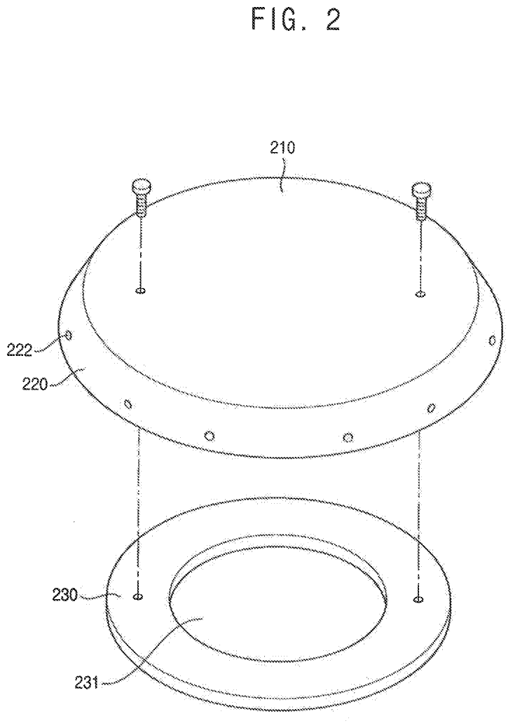

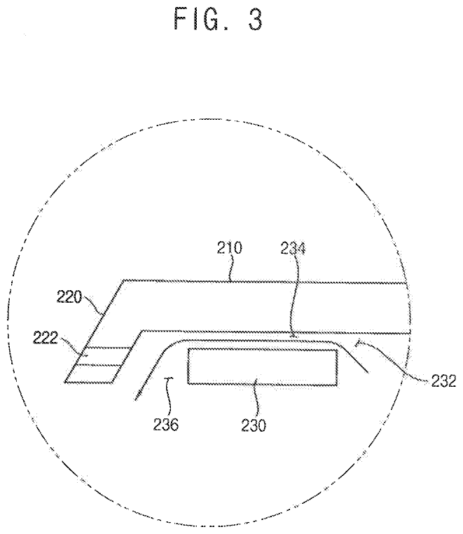

FIG. 1 is a cross-sectional view illustrating an apparatus for cleaning a bowl of a spin coater according to an exemplary embodiment of the present inventive concept, FIG. 2 is an enlarged exploded perspective view illustrating a jig of the apparatus in FIG. 1 according to an exemplary embodiment of the present inventive concept, and FIG. 3 is an enlarged cross-sectional view of a portion III in FIG. 1 according to an exemplary embodiment of the present inventive concept.

Referring to FIGS. 1 to 3, a spin coater may coat a photoresist on a substrate. The spin coater may include a spin chuck 110, a nozzle and a bowl 120.

The spin chuck 110 may fix the substrate using vacuum. The substrate may be fixed to an upper surface of the spin chuck 110. The spin chuck 110 may rotate the substrate.

The nozzle may be arranged over the spin chuck 110. The nozzle may inject the photoresist to a central portion of an upper surface of the substrate disposed on the spin chuck 110. Because the substrate may be rotated by the spin chuck 110, the photoresist injected from the nozzle may receive a centrifugal force along a radius direction of the spin chuck 110. Thus, the photoresist injected to the central portion of the substrate may be moved toward an edge portion of the substrate so that the photoresist may be uniformly coated on the upper surface of the substrate.

The bowl 120 may be configured to at least partially surround the spin chuck 110. For example, side surfaces and a lower surface of the spin chuck 110 may be surrounded by the bowl 120. The bowl 120 may collect and discharge the photoresist overflowed from an edge portion of the substrate. The bowl 120 may include a discharge container 122, an outer cover 124 and an inner cover 126.

The discharge container 122 may include a discharge plate 122a, an outer wall 122b, an inner wall 122c and a blocking wall 122d. The discharge plate 122a may be horizontally arranged under the spin chuck 110. For example, the discharge plate 122a may extend parallel to the spin chuck 110. The outer wall 122b may be upwardly extended from an outer end of the discharge plate 122a. For example, the outer end of the discharge plate 122a may be the furthest end of the discharge plate 122a from the spin chuck 110. The inner wall 122c may be upwardly extended from an inner end of the discharge plate 122a. For example, the inner end of the discharge plate 122a may be opposite to the outer end of the discharge plate 122a. The blocking wall 122d may be upwardly extended from the discharge plate 122a between the outer wall 122b and the inner wall 122c. For example, the blocking wall 122d may upwardly extend from a middle portion of the discharge plate 122a.

A first discharge hole 127 may be formed through a portion of the discharge plate 122a between the outer wall 122b and the blocking wall 122d. The photoresist may be discharged from the bowl 120 through the first discharge hole 127. A second discharge hole 128 may be formed through a portion of the discharge plate 122a between the blocking wall 122d and the inner wall 122c. Air may be discharged through the second discharge hole 128.

The outer cover 124 may be connected to an upper end of the outer wall 122b of the discharge container 122. For example, the upper end of the outer wall 122b may be opposite to the end of the outer wall 122b connected to the discharge plate 122a. The outer cover 124 may induce the photoresist scattered from the substrate in the radius direction toward the discharge container 122. For example, the photoresist scattered from the substrate in the radius direction may collide against an inner surface of the outer cover 124. For example, the outer cover 124 may extend towards the spin chuck 110 at a predetermined angle with respect to the outer wall 122b. The photoresist may then move to the discharge container 122 by a load of the photoresist. The photoresist induced to the discharge container 122 may be discharged through the first discharge hole 127. The air moved together with the photoresist may be discharged through the second discharge hole 128.

In an exemplary embodiment of the present inventive concept, the outer cover 124 may include a vertical portion 124a and a slant portion 124b. For example, the vertical portion 124a may be vertically extended from the upper end of the outer wall 122b. The slant portion 124b may extend from an upper end of the vertical portion 124a toward the central portion of the spin chuck 110 at a predetermined angle with respect to the vertical portion 124a. In addition, the outer cover 124 may have other shapes as well as the above-mentioned shape.

The inner cover 126 may be connected to the upper end of the inner wall 122c of the discharge container 122. For example, the upper end of the inner wall 122c may be opposite to the end of the inner wall 122c connected to the discharge plate 122a. The inner cover 126 may include a horizontal blocking portion 126a and a vertical blocking portion 126b. The horizontal blocking portion 126a may be horizontally extended from the upper end of the inner wall 122c over the blocking wall 122d. For example, horizontal blocking portion 126a may extend parallel to the spin chuck 110. The vertical blocking portion 126b may be extended from an end of the horizontal blocking portion 126a toward an upper surface of the discharge plate 122a. For example, the vertical blocking portion 126b may extend from an end of the horizontal blocking portion 126a that is opposite to the end of the horizontal blocking portion 126a that is connected to the inner wall 122c. The vertical blocking portion 126b may have an inner surface spaced apart from an outer surface of the blocking wall 122d. For example, the vertical blocking portion 126b may face the blocking portion 126b.

Therefore, the photoresist induced to the discharge plate 122a may be blocked by the blocking wall 122d and the vertical blocking portion 126b so that the photoresist may not be moved to the second discharge hole 128. In addition, the air induced to the discharge plate 122a may be moved to the second discharge hole 128 through a space between the vertical blocking portion 126b and the discharge plate 122a, and a space between the vertical blocking portion 126b and the blocking wall 122d. For example, there may be a space between horizontal blocking portion 126a and the blocking wall 122d for air induced to the discharge plate 122a to be moved to the second discharge hole 128.

The photoresist scattered in the radius direction of the substrate may be stained on the inner surface of the outer cover 124 and the outer surface of the inner cover 126. The photoresist on the inner surface of the outer cover 124 and the outer surface of the inner cover 126 may contaminate the substrate in following coating processes. To remove the photoresist on the inner surface of the outer cover 124 and the outer surface of the inner cover 126, an apparatus for cleaning the bowl 120 may be provided to the spin coater. The cleaning apparatus may include a jig 200, a lower nozzle 300, an upper nozzle 400 and a robot arm 500. The jig 200 may include a base 210, a guide member 220 and a lower guide plate 230.

The base 210 may be placed on the upper surface of the spin chuck 110. The base 210 may be fixed to the upper surface of the spin chuck 110 by a vacuum pressure provided from the spin chuck 110. For example, a lower surface of the base 210 may be fixed to the upper surface of the spin chuck 110. The base 210 may be rotated by the spin chuck 110. The base 210 may have a circular plate shape. The base 210 may have a diameter longer than that of the spin chuck 110. Thus, the base 210 may have an outer side surface extending beyond the spin chuck 110 in the radius direction.

The guide member 220 may be downwardly extended from an edge portion of the base 210. The guide member 220 may be extended toward the inner cover 126 to induce the lower cleaning agent injected from the lower nozzle 300 to the inner cover 126 of the bowl 120. According to an exemplary embodiment of the present inventive concept, the inner cover 126 may be positioned outside the outer surface of the base 210. For example, the inner cover 126 may be separated from the outer surface of the base 210 and may overlap the base 210 and the guide member 220. Thus, to induce the lower cleaning agent to the inner cover 126 of the bowl 120, an angle between an inner surface of the guide member 220 and the lower surface of the base 210 may be an obtuse angle. In addition, the angle between the inner surface of the guide member 220 and the lower surface of the base 210 may be changed in accordance with positions of the inner cover 126. For example, the angle between the inner surface of the guide member 220 and the lower surface of the base 210 may be a right angle or an acute angle.

The guide member 220 may include at least one inject hole 222. The inject hole 222 may be horizontally formed through the guide member 220 to inject the lower cleaning agent toward the outer cover 124 of the bowl 120. For example, there may be a plurality of inject holes 222 spaced apart from each other by a uniform gap. In addition, the inject holes 222 may be spaced apart from each other with varying gaps therebetween.

According to an exemplary embodiment of the present inventive concept, the guide member 220 may be integrally formed with the base 210. The guide member 220 and the base 210 may form one body. However, the present inventive concept is not limited thereto. For example, the guide member 220 may be separated from the base 210.

The lower guide plate 230 may be arranged under the base 210. The lower guide plate 230 may be fixed to the lower surface of the base 210 using a bolt. The lower guide plate 230 may have an annular shape. The lower guide plate 230 may have an inner surface spaced apart from the spin chuck 110. Thus, a lower inflow groove 232 may be formed between the lower guide plate 230 and the spin chuck 110. The lower cleaning agent injected from the lower nozzle 300 may flow into the lower inflow groove 232. The lower guide plate 230 may have an upper surface spaced apart from the lower surface of the base 210. Thus, a lower passageway 234 may be formed between the lower guide plate 230 and the base 210. The lower passageway 234 may be in fluidic communication with the lower inflow groove 232. For example, the lower inflow groove 232 and the lower passageway 234 may form a path for the lower cleaning agent to travel in. The lower cleaning agent may pass through the lower passageway 234. Further, the lower guide plate 230 may have an outer surface spaced apart from the inner surface of the guide member 220. Thus, a lower injection groove 236 may be formed between the lower guide plate 230 and the guide member 220. The lower injection groove 236 may be oriented toward the inner cover 126 of the bowl 120.

The lower nozzle 300 may be arranged under the spin chuck 110. The lower nozzle 300 may include at least one nozzle. The lower nozzle 300 may be inclined to the lower surface of the base 210. For example, the lower nozzle 300 may face the lower surface of the base 210 at an angle. Thus, the lower nozzle 300 may inject the lower cleaning agent toward the lower surface of the base 210 in a direction inclined to the lower surface of the base 210. The lower cleaning agent injected from the lower nozzle 300 may be introduced into the lower passageway 234 through the lower inflow groove 232. Because the base 210 may be rotated by the spin chuck 110, the centrifugal force may be applied to the lower cleaning agent. Therefore, after the lower cleaning agent may be moved to the guide member 220 through the lower passageway 234, the lower cleaning agent may then be injected to the inner cover 126 of the bowl 120 through the lower injection groove 236. As a result, the photoresist on the inner cover 126 may be removed by the lower cleaning agent injected through the lower injection groove 236. According to an exemplary embodiment of the present inventive concept, the lower cleaning agent may include a thinner.

Further, the lower cleaning agent moved through the lower passageway 234 may be injected to the outer cover 124 of the bowl 120 through the injection holes 222. Thus, the photoresist on the outer cover 124 may be removed by the lower cleaning agent injected through the injection holes 222.

The upper nozzle 400 may be arranged over the spin chuck 110. The upper nozzle 400 may be substantially perpendicular to the upper surface of the base 210. The upper nozzle 400 may inject an upper cleaning agent toward a central portion of the upper surface of the base 210. Because the base 210 may be rotated by the spin chuck 110, the upper cleaning agent injected toward the central portion of the upper surface of the base 210 may be induced along the radius direction of the base 210. Thus, the upper cleaning agent may be injected toward the outer cover 124 of the bowl 120 to remove the photoresist on the outer cover 124. According to an exemplary embodiment of the present inventive concept, the upper cleaning agent may include a thinner.

According to an exemplary embodiment of the present inventive concept, the cleaning apparatus may include the injection hole 222 of the guide member 220. In addition, when the photoresist on the outer cover 124 may be removed by only the upper cleaning agent, the cleaning apparatus may not include the injection hole 222. Further, when the photoresist on the outer cover 124 may be removed by only the lower cleaning agent injected through the injection hole 222, the cleaning apparatus may not include the upper nozzle 400.

The robot arm 500 may load/unload the jig 200 into/from the spin chuck 110. The robot arm 500 may be configured to make contact with the lower surface of the lower guide plate 230 of the jig 200. Because the lower cleaning agent may flow into the lower passageway 234, the lower cleaning agent may be stained on the lower surface of the base 210 and the upper surface of the lower guide plate 230. In addition, the lower cleaning agent may not be stained on the lower surface of the lower guide plate 230. For example, the lower surface of the lower guide plate 230 may not be contaminated by the lower cleaning agent. Thus, during the transfer of the jig 200 by the robot arm 500, the robot arm 500 may make contact with the non-contaminated lower surface of the lower guide plate 230 so that the robot arm 500 may not be contaminated.

Further, the robot arm 500 may load the substrate into the spin chuck 110. The robot arm 500 may unload the substrate from the spin chuck 110. For example, the robot arm 500 of the cleaning apparatus may correspond to a robot arm for transferring the substrate used in the spin coater and not an additional robot arm. Therefore, as mentioned above, because the robot arm 500 may make contact with the non-contaminated lower surface of the lower guide plate 230, the substrate as well as the robot arm 500 may not be contaminated.

According to an exemplary embodiment of the present inventive concept, the robot arm 500 for transferring the substrate may also transfer the jig 200 so that the process for cleaning the bowl 120 may be performed without stopping the spin coater. As a result, the operating ratio of the spin coater may be increased. Further, because a worker may not take part in the process for cleaning the bowl 120 of the spin coater, the worker may not be exposed to noxious byproducts generated in the coating process.

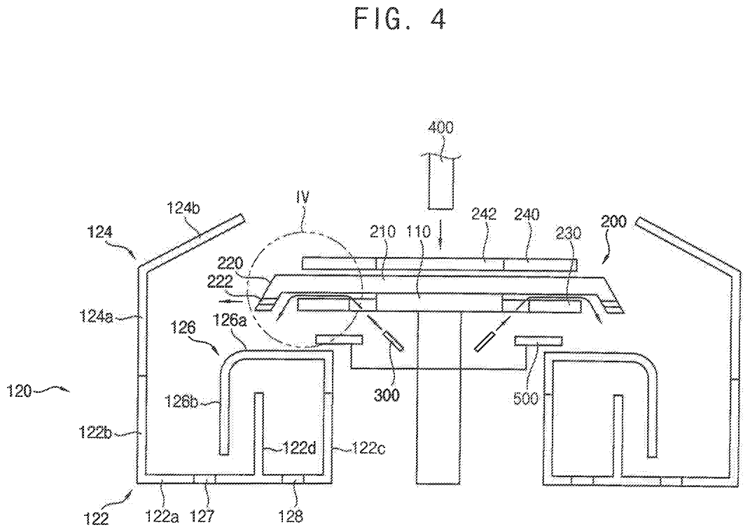

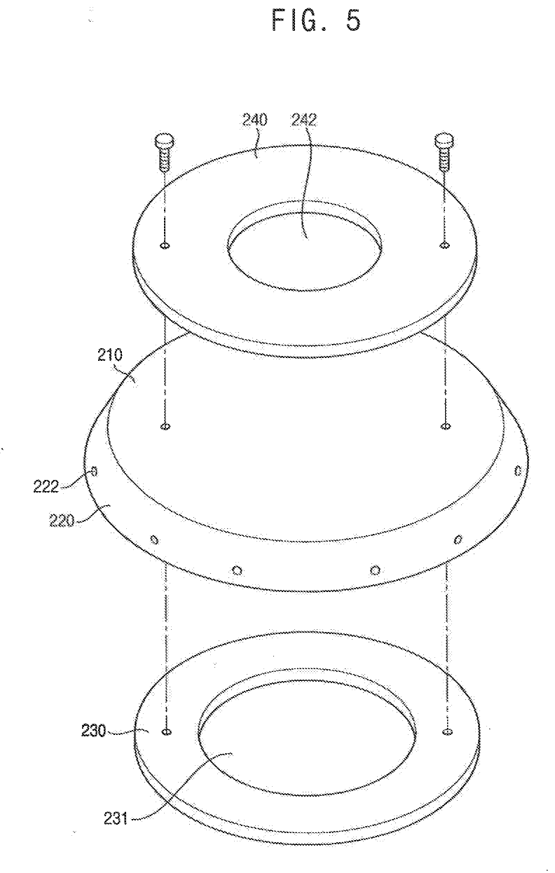

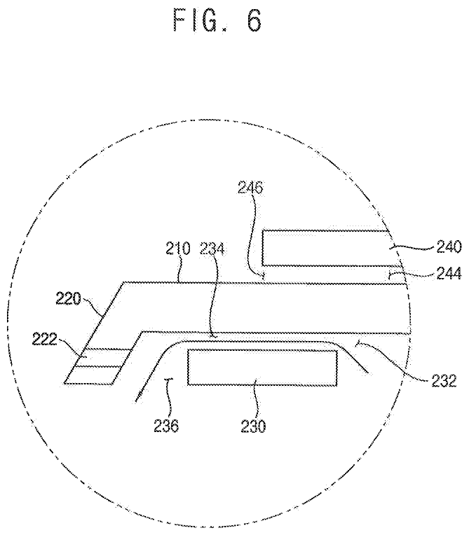

FIG. 4 is a cross-sectional view illustrating an apparatus for cleaning a bowl of a spin coater in according to an exemplary embodiment of the present inventive concept, FIG. 5 is an enlarged exploded perspective view illustrating a jig of the apparatus in FIG. 4 according to an exemplary embodiment of the present inventive concept, and FIG. 6 is an enlarged cross-sectional view of a portion VI in FIG. 4 according to an exemplary embodiment of the present inventive concept.

An apparatus for cleaning a bowl, according to an exemplary embodiment of the present inventive concept, may include elements and/or components that may be substantially the same as those of the cleaning apparatus in FIG. 1 except for an upper guide plate 240. Thus, the same reference numerals may refer to the same elements and any repetitive descriptions with respect to the same elements may be omitted.

Referring to FIGS. 4 to 6, the upper guide plate 240 may be arranged over the base 210. The upper guide plate 240 may be fixed to the base 210 using a bolt. For example, the upper guide plate 240 may have an annular shape.

The upper guide plate 240 may have an upper inflow groove 242, an upper passageway 244 and an upper injection groove 246. The upper inflow groove 242 may be formed at a central portion of the upper guide plate 240 under the upper nozzle 400. The upper guide plate 240 may have a lower surface spaced apart from the upper surface of the base 210. Thus, the upper passageway 244 may be formed between the upper guide plate 240 and the base 210. The upper passageway 244 may be in fluidic communication with the upper inflow groove 242. For example, the upper passageway 244 may receive the upper cleaning agent from the upper inflow groove 242. The upper cleaning agent may pass through the upper passageway 244. The upper guide plate 240 may have an edge portion spaced apart from the upper surface of the base 210 to form the upper injection groove 246 between the edge portion of the upper guide plate 240 and the base 210. For example, the upper guide plate 240 may have a diameter smaller than that of the jig 200. The upper injection groove 246 may be in fluidic communication with the upper passageway 244. For example, the upper injection groove 246 may receive the upper cleaning agent from the upper passageway 244. The upper injection groove 246 may be oriented toward the outer cover 124 of the bowl 120.

The upper cleaning agent injected from the upper nozzle 400 may flow into the upper passageway 244 through the upper inflow groove 242. Because the base 210 may be rotated by the spin chuck 110, the centrifugal force may be applied to the upper cleaning agent. Thus, the upper cleaning agent may be injected to the outer cover 124 of the bowl 120 through the upper passageway 244 and the upper injection groove 246. As a result, the photoresist on the outer cover 124 may be removed by the upper cleaning agent injected from the upper injection groove 246.

For example, when the photoresist on the outer cover 124 may be removed by only the upper cleaning agent, the cleaning apparatus may include the guide member 220 without the injection hole 222.

Exemplary embodiments of the present inventive concept provide a jig for cleaning a bowl of a spin coater, and the jig may effectively clean the bowl without stopping the spin coater.

Exemplary embodiments of the present inventive concept provide an apparatus for cleaning a bowl of a spin coater including the above-mentioned jig.

According to an exemplary embodiment of the present inventive concept, the guide member may guide the lower cleaning agent to the inner cover of the bowl. Thus, a photoresist on the inner cover may be effectively removed using the lower cleaning agent. For example, because the jig may be loaded/unloaded into/from the spin chuck by the robot arm, the cleaning process may be performed without stopping the spin coater so that an operating ratio of the spin coater may be increased.

While the present inventive concept has been particularly shown and described with reference to exemplary embodiments thereof, it will be apparent to those of ordinary skill in the art that various changes in form and detail may be made thereto without departing from the spirit and scope of the present inventive concept.

What is claimed is:

1. A jig configured to clean a bowl of a spin coater, the jig comprising:
a base disposed on a spin chuck of the spin coater, the base being configured to rotate by the spin chuck; and
a guide member extending in a first direction from an edge portion of the base toward an inner cover of the bowl and configured to guide a lower cleaning agent injected to a lower surface of the base to the inner cover of the bowl, wherein the inner cover of the bowl is configured to receive photoresist from under the spin chuck.

2. The jig of claim 1, wherein an angle between an inner surface of the guide member and the lower surface of the base is an obtuse angle.

3. The jig of claim 1, wherein the guide member includes a first injection hole configured to inject the lower cleaning agent to an outer cover of the bowl at a side of the spin chuck.

4. The jig of claim 3, wherein the guide member includes a plurality of first injection holes spaced apart from each other by a common distance.

5. The jig of claim 1, wherein the guide member is integrally formed with the base.

6. The jig of claim 1, further comprising a lower guide plate disposed under the base and forming a lower passageway with the base, wherein the lower passageway is configured to guide the lower cleaning agent toward the guide member.

7. The jig of claim 6, wherein the lower guide plate has an outer surface spaced apart from an inner surface of the guide member and forms a lower injection groove with the inner surface of the guide member, wherein the lower injection groove is configured to inject the lower cleaning agent toward the inner cover of the bowl.

8. The jig of claim 1, further comprising an upper guide plate disposed over the base and forming an upper passageway with the base, wherein the upper passageway is configured to guide an upper cleaning agent injected to an upper surface of the base to an outer cover of the bowl at a side of the spin chuck.

9. A jig configured to clean a bowl of a spin coater, the jig comprising:
a base disposed on a spin chuck of the spin coater, the base being configured to rotate by the spin chuck;
a guide member extending in a first direction from an edge portion of the base toward an inner cover of the bowl and configured to guide a lower cleaning agent injected to a lower surface of the base to the inner cover of the bowl, wherein the inner cover of the bowl is configured to receive photoresist from under the spin chuck;
a lower guide plate disposed under the base and forming a lower passageway with the base, wherein the lower passageway is configured to guide the lower cleaning agent toward the guide member; and
an upper guide plate disposed over the base and forming an upper passageway with the base, wherein the upper passageway is configured to guide an upper cleaning agent injected to an upper surface of the base to an outer cover of the bowl at a side of the spin chuck.

10. The jig of claim 9, wherein an angle between an inner surface of the guide member and the lower surface of the base is an obtuse angle.

11. The jig of claim 9, wherein the guide member has a first injection hole configured to inject the lower cleaning agent to the outer cover of the bowl at a side of the spin chuck.

12. The jig of claim 9, wherein the guide member is integrally formed with the base.

13. The jig of claim 9, wherein the lower guide plate has an outer surface spaced apart from an inner surface of the guide member and forms a lower injection groove with the inner surface of the guide member, wherein the lower injection groove is configured to inject the lower cleaning agent toward the inner cover of the bowl.

14. An apparatus configured to clean a bowl of a spin coater, the apparatus comprising:
a jig including:
a base disposed on a spin chuck of the spin coater, the base being configured to rotate by the spin chuck; and
a guide member extending in a first direction from an edge portion of the base toward an inner cover of the bowl and configured to guide a lower cleaning agent injected to a lower surface of the base to the inner cover of the bowl, wherein the inner cover of the bowl is configured to receive photoresist from under the spin chuck;
a lower nozzle disposed under the base to inject the lower cleaning agent toward the lower surface of the base; and
an upper nozzle disposed over the base to inject an upper cleaning agent toward an upper surface of the base.

15. The apparatus of claim 14, wherein the guide member includes at least one injection hole configured to inject the lower cleaning agent to an outer cover of the bowl at a side of the spin chuck.

16. The apparatus of claim 14, wherein the jig further comprises a lower guide plate disposed under the base and forming a lower passageway with the base, wherein the lower passageway is configured to guide the lower cleaning agent toward the guide member.

17. The apparatus of claim 14, wherein the jig further comprises an upper guide plate disposed over the base and forming an upper passageway with the base, wherein the upper passageway is configured to guide the upper cleaning agent to an outer cover of the bowl at a side of the spin chuck.

18. The apparatus of claim 14, wherein the lower nozzle is arranged at an angle with respect to the lower surface of the base to inject the lower cleaning agent toward the lower surface of the base.

19. The apparatus of claim 14, wherein the upper nozzle is disposed over a central portion of the base to inject the upper cleaning agent in a direction substantially perpendicular to the upper surface of the base.

20. The apparatus of claim 14, further comprising a robot arm configured to load the jig into the spin chuck, and to unload the jig from the spin chuck.
